(19) United States
(12) Patent Application Publication
(10) Pub. No.: US 2011/0261970 A1
(43) Pub. Date: Oct. 27, 2011

(54) NOISE MODIFYING OVERHEAD AUDIO SYSTEM

(75) Inventors: Lawrence Robert Hamelink, Hamilton, MI (US); Peter C. Laux, Holland, MI (US); Brian K. Servis, Holland, MI (US)

(73) Assignee: JOHNSON CONTROLS TECHNOLOGY COMPANY, Holland, MI (US)

(21) Appl. No.: 13/124,204

(22) PCT Filed: Oct. 21, 2009
(86) PCT No.: PCT/US09/61395

§ 371 Date: Jul. 11, 2011

Related U.S. Application Data
(60) Provisional application No. 61/107,206, filed on Oct. 21, 2008.

(51) Int. Cl. G10K 11/16

(52) U.S. Cl. 381/71.4

(57) ABSTRACT

An overhead audio system for use in a vehicle, the overhead audio system includes multiplexor for receiving an input signal from a plurality of audio sources and for transmitting an output signal; a noise detection sensor for detecting a noise and providing noise data; an audio processor for processing the output signal received from the multiplexor and for receiving the noise data from the noise detection sensor, wherein the audio processor processes the output signal based on the noise data and transmits the processed output signal to a speaker; and wherein the overhead audio system is housed within a headliner of the vehicle.

### CROSS-REFERENCE TO RELATED APPLICATIONS

The present application is a U.S. National Stage filing of International Application No. PCT/US2009/061395, filed on Oct. 21, 2009, titled “NOISE MODIFYING OVERHEAD AUDIO SYSTEM”, which claims priority to U.S. Provisional Patent Application No. 61/107,206, filed Oct. 21, 2008, the entire disclosures of which are incorporated herein by reference.

### FIELD

This disclosure relates to a noise modifying audio system. More particularly, This disclosure relates to a noise modifying overhead audio system for use in a vehicle.

### BACKGROUND

It is known to provide an audio system within the interior of a vehicle. These audio systems may typically include an AM/FM radio, satellite radio tuner, a TV tuner, a compact disc (CD) player, digital media player, a cassette tape player and/or other inputs as well as speakers installed in the front dash, center console, door panels and rear compartments of the vehicle. Controls for these audio systems are typically located in the front dash, center console and/or on a steering wheel of the vehicle.

It is also known to provide vehicular audio systems with connections for external devices. For example, some vehicular audio systems include auxiliary inputs for connection to external analog audio sources. Other vehicular audio systems include universal serial bus (USB) ports or docks for connecting to external digital audio sources or external digital file storage devices.

In a typical vehicular audio system, the AM/FM radio, the CD player and the cassette tape player are each, if present, located within a single housing, often generically referred to as a stereo radio or system, installed within a front dash of the vehicle. The stereo radio or system connects to speakers, either directly or through amplifiers, filters or the like, located throughout the front dash, side panels, floor and/or rear compartment of the vehicle.

It is also known to provide noise cancelling subsystems for audio systems. For example, some types of high-end headphones include noise cancelling features that sample ambient noise around the user and use noise cancellation techniques or methods to reduce or eliminate the intensity or volume of the ambient noise as perceived by the user.

### SUMMARY

A headliner for a vehicle comprises an audio system usable to cancel, filter or alter noise experienced in a cabin of the vehicle, The audio system comprises an audio signal input device, which may include one or more of an AM/FM radio, a compact disc or other optical disc player, a cassette tape player, a digital audio player, an auxiliary audio input, a Bluetooth or other wireless audio input and/or a connection to an output of a second audio system. The audio system also comprises one or more noise detection sensors that are usable to provide one or more noise signals that represents sampled, expected and/or detected noise in the cabin of the vehicle and input such noise signals to the audio system. The audio system also comprises at least one speaker and an audio processor that modifies an audio signal received by the audio input and/or provides an audio signal to the at least one speaker. The audio processor is also usable to identify and/or characterize the one or more noise signals input via the one or more noise detection sensors. The audio system may selectively filter, cancel, alter or replace a resulting noise experienced in the cabin of the vehicle represented in the one or more noise signals from the noise detection sensors by providing a noise modifying audio signal to the one or more speakers.

A headliner for a vehicle comprises an audio system. The audio system comprises at least one of an AM/FM radio, a compact disc or other optical disc player, a cassette tape player, a digital audio player, an auxiliary audio input and a Bluetooth or other wireless audio input. The audio system also comprises one or more noise detection sensors that are usable to provide a noise signal that represents sampled, expected and/or detected noise experienced in a cabin of the vehicle and input such noise signals to the audio system. The audio system also comprises an audio processing device, at least one speaker, a user interface having at least one of at least one button and at least one screen.

A headliner for a vehicle comprises an audio subsystem. The audio subsystem comprises at least one speaker, and an audio processor usable to modify an audio stream provided to the at least one speaker. The audio subsystem interacts with an audio system of the vehicle to provide the audio stream to the at least one speaker.

A complete audio system and/or subsystem are provided in the headliner of a vehicle. The audio system and/or subsystem include speakers, control features and signal processing devices for modifying an audio stream to be provided to the speakers. The audio stream can be modified to include a noise cancellation signal. The audio system and/or subsystem include controls and a user interface and/or interact with controls and a user interface of a separate audio system provided elsewhere within the vehicle interior.

### DRAWINGS

Various exemplary embodiments of the systems and methods according to this disclosure will be described in detail, with reference to the following Figures, wherein:

FIG. 1 is a block diagram of an exemplary embodiment of an audio system according to the disclosure;

FIG. 2 is a perspective view of a vehicle that includes a first exemplary embodiment of an audio subsystem according to the disclosure;

FIG. 3 is a perspective view of a vehicle that includes a second exemplary embodiment of an audio subsystem according to this invention;

FIG. 4 is a perspective view of a vehicle that includes an exemplary embodiment of a complete audio system according to the disclosure; and

FIG. 5 is a schematic view of an exemplary embodiment of a noise cancelling system according to the disclosure.

### DESCRIPTION

It should be appreciated that, for the purposes of the following disclosure, the term “noise” may be understood to include any undesired sound present in the cabin of a vehicle. In some instances, such noise is generated outside of the vehicle and is transmitted into the vehicle such that it can be perceived within the interior of the vehicle. During such transmission, the external sounds may be naturally altered such that the noise experienced in the vehicle interior is not the same as the sound heard outside of the vehicle. Additionally, noise may be generated from physical interactions that may not necessarily create a sound outside of the vehicle. For instance, noise generated by wind passing around the vehicle may be heard in the vehicle interior but may not be audible outside of the vehicle. Likewise noise may be generated by vibrations, friction or other interactions involving parts or components of the vehicle, particularly when those parts and/or components are moving relative to each other.

Additionally, it should be understood that such an externally generated noise is present in the vehicle cabin even if the noise has been modified, or even canceled or eliminated, as outlined below. As such, noise may be present and/or experienced in the vehicle interior/cabin but not specifically heard by occupants of the cabin due to the noise having been modified.

It should also he appreciated that, for the purposes of the following disclosure, the term “noise modification” may be understood to include any and all changing, attenuating or altering of an undesired sound, amplifying a desired sound, replacing an undesired sound with a desired sound or otherwise modifying a sound heard in the interior of the vehicle. Such noise modification may include combining a desired sound (e.g., sound from an audio source of an audio system) with a modifying sound wave intended to modify an additional sound. in various instances, the additional sound is an undesired sound (e.g., noise in the interior of the vehicle), while in other instances the additional sound is a desired sound (e.g., a siren from an emergency vehicle).

It should also be appreciated that the speaker(s) of the vehicle may be any known or later-developed type of analog and/or digital device that is capable of producing sound, such as, for example but not limited to, tweeters, mid-range speakers, full-range speakers, woofers, subwoofers and/or an excited headliner, which received an input from a transducer.

Advancements in audio signal processing algorithms have made it possible to use smaller speakers to produce sound at a quality equal to or greater than larger speakers used with inferior audio signal processing algorithms. Using smaller speakers allows the speakers to be placed in locations that would not accommodate larger speakers. One such location is the headliner of a vehicle. In particular, advanced audio signal processing algorithms permit using smaller speakers as woofers and/or subwoofers, while providing sound at a quality equal to or greater than larger woofers and/or subwoofers used with inferior audio signal processing algorithms. These smaller woofers and/or subwoofers can be installed in vehicle headliners and other locations where larger woofers and/or subwoofers do not fit or have other problems and draw backs.

Installing speakers, woofers and/or subwoofers in the headliner of the vehicle provides additional usable space in the front dash, center console, door panels and/or rear compartment of the vehicle that would otherwise be occupied by the speakers, woofers and/or subwoofers. This additional space can be used for other purposes, such as, for example, storage, interactive screens or vehicle controls,

Furthermore, placing speakers, woofers and/or subwoofers in the headliner of the vehicle in addition to, or in place of, other speakers, woofers and/or subwoofers located elsewhere throughout the vehicle interior provides an improved audio experience. Speakers, woofers and/or subwoofers that are placed in the headliner of the vehicle are closer to the ear level of a driver and passengers of the vehicle. As such, sound emitted by the speakers, woofers and/or subwoofers experiences less distortion and interference while traveling through the interior space of the vehicle to the driver's or passengers' ears. Likewise, speakers, woofers and/or subwoofers that are located in the headliner of the vehicle can be more directionally oriented, offering a superior sound quality to each user, e.g., the passengers and/or the driver, of the vehicle. Speakers, woofers and/or subwoofers can be placed in optimal locations relative to the driver and/or one or more passengers of the vehicle, locations that would otherwise not be available to larger speakers, woofers and/or subwoofers.

Placing speakers, woofers and/or subwoofers in a headliner of a vehicle may also provide an improved opportunity for noise cancellation and/or noise modification. The speakers, woofers and/or subwoofers may be used to provide an audio signal that is usable to cancel or modify noise from the surrounding environment. This audio signal may also include a modified and/or desired sound. Speakers, woofers and/or subwoofers that are located in the headliner of the vehicle may be closer to the ear level of the driver and passengers of the vehicle. As such, sound produced by the speakers, woofers and/or suhwoofers may reach the driver and/or passengers quicker allowing more time for noise cancellation processing. The speakers, woofers and/or subwoofers may he grouped into one or more zones, which allow for noise cancellation and/or modification between zones.

For example, sounds generated in a rear zone of the vehicle cabin (e.g., conversations between occupants of a second row of the vehicle and the like) may be canceled as noise in a front zone of the vehicle as experienced by occupants of a front row of the vehicle. Likewise, sounds from the front zone may be amplified in the rear zone to, for example, help occupants of the front row be heard by occupants of the second row. Additionally, the zones may be provided with a desired audio source that differs from the desired audio source of a neighboring zone and may include signals that are usable to cancel the desired audio source of that neighboring zone.

It should be appreciated that speakers, woofers and/or subwoofers may be installed in the headliner of a vehicle in various positions, such as those described in U.S. Pat. No. 5,754,664, which is incorporated herein by reference in its entirety. Additionally, the speakers, woofers and/or suhwoofers may be mounted to the headliner using a mounting system such as that described in U.S. Pat. No. 5,699,438, which is incorporated herein by reference in its entirety.

In addition, advancements in audio signal processing and portable audio systems have reduced the space necessary for other components of a vehicle audio system. For example, radio tuners are available as integrated circuit chips, requiring far less space than traditional radio tuners. As such, a fully functional audio system requires less space than previous embodiments and can be installed in locations that would not accommodate larger systems. Additionally, portable audio devices have replaced much of the functionality of compact disc (CD) or other optical disc players, cassette tape players and AM/FM radios. In many cases, it is possible to rely on portable devices to provide most or all of the audio input and/or processing functionality typically handled by the radio, antenna. CD or other optical disc player and/or cassette tape player. As such, these devices can optionally be omitted from an audio system without a substantial loss of functionality.

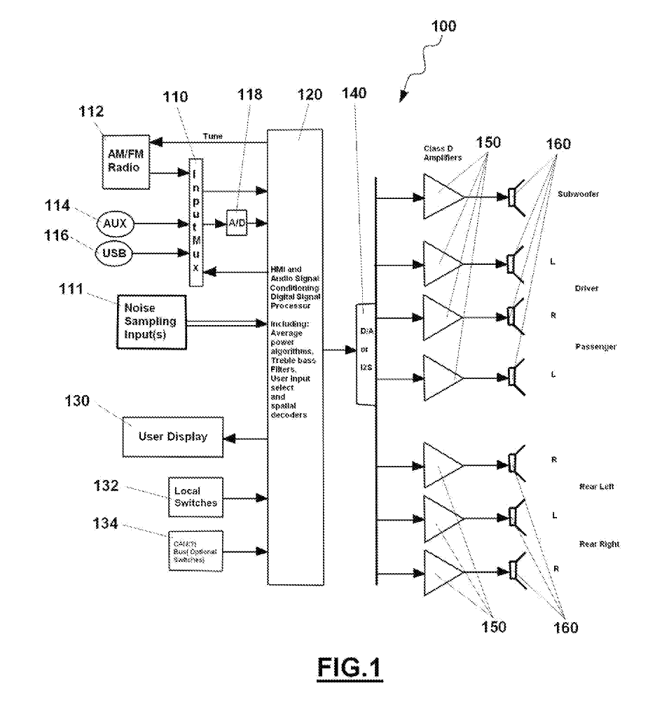

FIG. 1 shows an exemplary embodiment of an audio system 100 according to the disclosure. As shown in FIG. 1, the audio system 100 includes an input multiplexor 110, a processor 120, a converter 140, a series of amplifiers 150 and a series of speakers 160. The input multiplexor 110 receives inputs from several audio sources, including one or more of an AM/FM radio 112, which may be provided on an integrated circuit, an auxiliary input 114, which may connect to external, portable audio devices, and a universal serial bus (USB) port 116, which may connect to external, portable audio devices and/or external storage devices. It should be appreciated that the input multiplexor 110 may receive inputs from other audio sources in addition to or in place of those shown. For example, the input multiplexor may receive an input, from a compact disc or other optical disc player, a cassette tape player and/or a Bluetooth or other wireless audio input, and/or any other known or later-developed audio source.

The input multiplexor 110 receives audio signals from the various input devices and outputs the audio signal from the desired audio source to the processor 120. If the desired audio source is an analog source, the output signal may be directed through an analog to digital converter 118 before continuing on to the processor 120.

The audio system 100 also includes one or more noise detection sensors 111. Each of the one or more noise detection sensors 111 provides information that represents a source of noise present in the interior of the vehicle including sounds produced by the vehicle (e.g., engine noise, transmission noise and the like), sounds transmitted through the vehicle (e.g., road noise, wind noise and the like), sounds generated within the vehicle (e.g., voices from a rear of the vehicle cabin, voices from a front of the vehicle cabin and the like) and sounds generated outside of the vehicle (e.g., construction noise, other vehicle noise and the like). The noise detection sensors 111 may include, for example, microphones, shock sensors, accelerometers, force sensors, transducers and/or the like.

It should be appreciated that, in various exemplary embodiments, the noise detection sensors 111 may detect secondary indicators or sources of noise rather than directly detecting sounds that produce such noise. For example, in various exemplary embodiments, the noise detection sensors 111 may include a transducer that detects vibrations generated by impacts with a driving surface. These vibrations will travel through the vehicle body and be experienced by the vehicle occupants as noise in the vehicle cabin. In general, each noise detection sensor 111 outputs information that indicates or represents one or more noise conditions within the vehicle cabin, to the processor 120.

The processor 120 receives the desired audio source either directly from the input multiplexor 110 or through the analog to digital converter 118. Additionally, as indicated above, the processor 110 also receives the information representative of noise in the vehicle cabin from the noise detection sensors 111.

The processor 120 also controls a tuning function of the AM/FM radio 112 and instructs the input multiplexor 110 which input source 112, 114 or 116 is the desired input source. The processor 120 also interacts with input and output devices, such as a user display or user interface 130, local switches 132 and/or a communications bus 134. A user of the audio system 100 inputs desired instructions (e.g., a selected band and frequency of the AM/FM radio 112, a desired audio source, volume, etc) using the local switches 132 and/or the communications bus 134. The instructions are then sent to the processor 120.

It should be appreciated that, in various conditions, the processor 120 may not receive any desired audio source, but may still receive the information from the one or more noise detection sensors 111. In such conditions, the processor 120 may generate or otherwise provide an audio signal in place of the desired audio source, which is based on the information contained in the signal received from the noise detection sensors 111.

The processor 120 further filters and modifies the audio signal from the desired audio source and/or the one or more noise detection sensors 111. Various algorithms, filters, amplifiers, encoders, decoders and/or other processing functions are applied to the audio signal by the processor 120 according to any known or later-developed audio processing algorithm or protocol.

If the processor 120 receives information from the one or more noise detection sensors 111, the processor 120 may incorporate that information into the audio processing algorithms, protocols and/or other aspects of the processed audio signal. For example, the volume of the processed audio signal may be increased in response to a sustained increase in the volume of noise in the vehicle cabin. Likewise, the processor 120 may alter the processed audio signal to compensate for noise in the vehicle cabin. For example, the processed audio signal may include an inverted sound wave of the sensed or determined noise (e.g., one or more sounds) present in the vehicle cabin. The inverted sound wave may he usable to attenuate or diminish the noise in the vehicle cabin. As such, the volume of the processed audio signal may not need to be increased, and may be reduced in response to attenuating or diminishing the noise in the vehicle cabin.

Additionally, the processed audio signal may be adjusted to replace the noise in the vehicle cabin. For example, the sound of the vehicles motor may be diminished and/or replaced with the sound of a different motor, such as, for example, a high-power or high-end motor, such as a V-12 motor, a supercharged motor, a turbocharged motor, an engine or motor noise, a multi-cylinder engine (e.g., 3-12 cylinder engine), a gasoline engine, a diesel engine, a electric motor, or the like. In general, the processed audio signal may be altered to include qualities that have the effect of reducing, replacing, altering, amplifying, eliminating or otherwise modifying noise present in the vehicle cabin as determined from the information collected by the one or more noise detection sensors 111.

The processed audio signal is sent by the processor 120 to a converter 140, such as a digital to analog converter and/or an integrated interchip sound interface, which, among other things, separates the audio signal into separate channels according to a desired speaker 160 that will output a given portion or channel of the audio signal.

The separate channels may include one or more channels that provide the modified, desired audio source and/or that provide the modified audio source generated from the information received from the noise detection sensors 111. As such, a single channel may provide audio based on the desired audio source, the noise present in the vehicle cabin or both. Each amplifier 150 receives one or more channel(s) from the converter 140 and amplifies the received channel(s) as needed before sending the received channel(s) to the appropriate one or more speaker(s) 160. The speakers 160 are provided throughout the headliner and/or at other locations within the vehicle interior.

It should be appreciated that several of the components of the audio system 100 may be located within the headliner and/or alternatively located elsewhere within the vehicle interior. For example, in various exemplary embodiments, the headliner may include the input multiplexor 120, the processor 140, the amplifiers 150 and the speakers 160, while the input devices 112, 114 and 116 are located in the front instrument panel of the vehicle. In various other exemplary embodiments, the headliner may include the amplifiers 150 and the speakers 160, while the other components are located elsewhere within the interior of the vehicle. In general, any of the components can be located within the headliner of the vehicle as appropriate. However, any of the components can be located elsewhere for any reason, including, for example, limitations of available space within the vehicle headliner, such as an overhead console.

It should also be appreciated that one or more of the noise detection sensors 111 may be located on an exterior of the vehicle. For example, a microphone may be provided on the exterior of the vehicle and may be usable to detect sounds originating from the exterior environment that travels through the vehicle and into the vehicle cabin as noise. Likewise, an accelerometer or other transducer may be provided somewhere on a suspension of the vehicle and/or a frame of the vehicle between a tire and the vehicle cabin. Such sensors may be usable to detect vibrations that are generated by impacts with the driving surface and are transmitted through a body of the vehicle and into the vehicle cabin as noise.

It should also be appreciated that, because sound may travel faster through different media (e.g., sound may travel faster through the physical structure of the vehicle than through the air) and because the signal from the one or more noise detection sensors 111 may travel to the processor 120 faster than sound traveling through the air, it is possible to detect sounds in and around the vehicle before such sounds pass through the vehicle and into the vehicle cabin or from one location within the vehicle cabin to another location within the vehicle cabin where those sounds are heard by a user of the vehicle as noise. As such, the audio system 100 may be able to provide real tune compensation for sounds originating in and/or around the vehicle.

It should also be appreciated that the audio system 100 may respond to specific ranges of noise (e.g., low frequency sounds), specific types of noise the sound of the engine) and/or any undesired noise (e.g., any noise detected that is not generated within the vehicle or by the audio system 100), The audio system 100 may also require tuning to compensate for the specific acoustical characteristics of the vehicle and the headliner (e.g., the timing of sound traveling through the vehicle or signals traveling to the processor). Such tuning may be done in a single, one-time tuning or may be done periodically as the characteristics of the vehicle change.

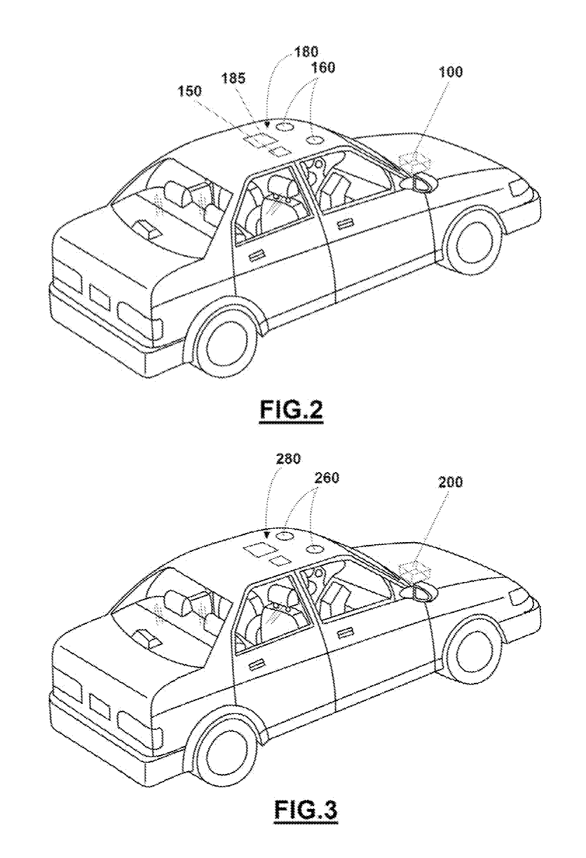

FIG. 2 shows a vehicle including a first exemplary embodiment of an audio subsystem 180 according to the disclosure. As shown in FIG. 2, the vehicle includes an audio system 100, which is located within a front dash of the vehicle. The audio system 100 may include the AM/FM radio 112, a CD or other optical disc player, a cassette tape player, the auxiliary input 114, the USB port 116, a digital audio player, a Bluetooth or other wireless audio input and/or any other known or later-developed audio source. In this exemplary embodiment, the audio system 100 processes an audio signal from the audio sources and sends the processed audio signal to the audio subsystem 180, which is behind a headliner of the vehicle. The audio subsystem 180 may then further process the audio signal before sending the signal to various speakers located throughout the headliner of the vehicle.

The audio subsystem 180 includes a processing unit 185, amplifiers 150 and speakers 160. The processing unit 185 further processes the audio signal received from the audio system 100 before forwarding the audio signal to the amplifiers 150 and speakers 160. The audio subsystem 180 may be usable to process audio signals that were intended for speakers located elsewhere within the vehicle interior, such that those audio signals can be output by the speakers 160 located in the headliner with acceptable sound quality. As such, the audio system 100 may not need to be altered to produce audio signals that are intended to be received by speakers located in the headliner.

Additionally, the audio subsystem 180 may be usable to further process the audio signal received from the audio system 100 to compensate for sounds present in or around the vehicle that are experienced by a user of the vehicle as noise within the vehicle cabin. For example, the audio subsystem 180 may increase the volume of the audio signal received from the audio system 100 in response to a sustained increase in the volume of other sounds present around the vehicle that are experienced by a user of the vehicle as noise within the vehicle cabin. Likewise, the audio subsystem 180 may alter the audio signal received from the audio system 100 to include an inverted sound wave usable to compensate for noise experienced in the vehicle cabin.

This embodiment allows an existing audio system to use speakers located in the headliner of the vehicle without requiring significant changes to how the existing audio system processes audio signals from the various audio sources. The additional processing, e.g., filtering, amplifying, splitting into channels, etc., is handled by the audio subsystem 180 located in the headliner. Likewise, this embodiment may allow noise cancelling features, which may he provided by the audio subsystem 180, to be added to the existing audio system 100.

It should be appreciated that an audio system is considered to be a generic term that may refer to an audio subsystem and/or a complete audio system. In general, if an audio system interacts with another audio system located elsewhere within the vehicle, each system may be referred to as an audio subsystem. Likewise, if an audio system does not interact with another audio system located elsewhere within the vehicle, it may be referred to as a complete audio system. The components present in an audio system do not dictate whether that audio system is an audio subsystem or a complete audio system. As such, it is possible, in various exemplary embodiments, for an audio subsystem to include components that a complete audio system lacks. Examples of these embodiments will be described in further detail below wherein like features of FIGS. 1-2 are represented by like features and reference numbers.

FIG. 3 shows a vehicle including a second exemplary embodiment of an audio subsystem 280 according to the disclosure. In this example, several components of the audio system 200 can be relocated or duplicated in the audio subsystem 280 located in the headliner. For example, the audio subsystem 280 may include an AM/FM radio 212, a CD or other optical disc player, a cassette tape player, an auxiliary input 214, a USB port 216, a digital audio player, a Bluetooth or other wireless audio input and/or any other known or later-developed audio source. Relocating components of the audio system 200 to the audio subsystem 280 located in the headliner makes more space available where the audio system 200 itself is located by eliminating components from the audio system 200.

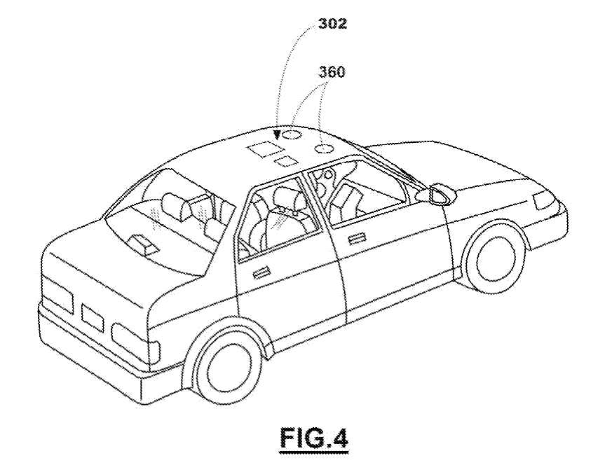

FIG. 4 shows a vehicle including an exemplary embodiment of a complete audio system 302 located in the headliner. In this example, each of the components of the generic audio system 100 of FIG. 2 can be located within the headliner of the vehicle as components of the complete audio system 302. By locating each of the components of the generic audio system 100 in the headliner of the vehicle, the complete audio system 302 can be manufactured and contained as a single unit. This may reduce costs, simplify wiring and/or offer other advantages over a split design including two or more audio systems/subsystems, such as the embodiment shown in FIG. 2, which includes the audio system 100 and the audio subsystem 180.

It should be appreciated that, as in the other exemplary embodiments, external devices may provide some of the features of the audio system. For example, an external media player may provide an AM and/or FM radio. In general, the complete audio system will include at least an audio input; a processing system, which may include filters, amplifiers and/or other audio signal modifiers; and at least one speaker. It should also be appreciated that any number of speakers may be provided.

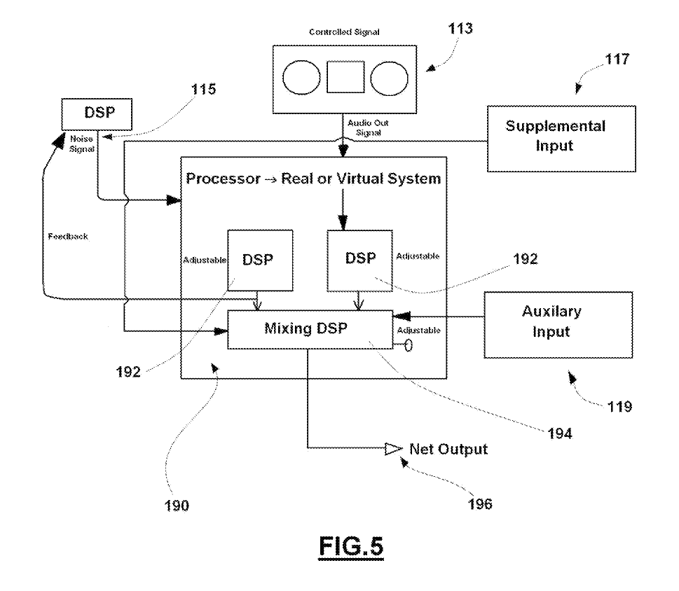

FIG. 5 shows a schematic representation of an exemplary noise cancellation system according to the disclosure. As shown in FIG. 5, an audio out signal 113, a noise signal 115, and a supplemental input 117 are input into a noise modifying processor 190. The noise modifying processor 190 may be an additional processing feature or function of the processor 120 described in connection with FIGS. 1-4 or may be a separate processor from the processor 120. As such, the functions or features described in connection with the noise modifying processor 190 may be features, elements or structures of the above-outlined audio system 100 or subsystems 180. 200.

The audio out signal 113 may be, for example, the desired audio source from any of the above-outlined inputs or an audio signal from another audio system. The noise signal 115 is a signal received from one or more of the noise detection sensors 111 and represents one or more noises experienced (or that will be experienced) in the vehicle cabin. The supplemental input 117 may be a stored replacement sound (e.g., a stored sound of a high end motor) usable to replace an undesired sound.

The noise modifying processor 190 includes digital signal processors 192 that process the various inputs. For example, the digital signal processor 192 will modify the audio out signal 113 to provide a signal usable with speakers located in the headliner of the vehicle. Likewise, the digital signal processor 192 will characterize, identify or otherwise process the noise signal 115. Such processing may include transforming a detected force, such as from an accelerometer, into a resultant noise signal that reflects the inverse of the expected noise that will be experienced in the vehicle cabin in response to the detected force. The digital signal processors 192 may need to be tuned and/or otherwise adjusted to compensate for the specific acoustic properties of the vehicle and/or to provide optimal results.

The noise modifying processor 190 also includes a mixing digital signal processor 194, The mixing digital signal processor 194 combines the processed signals from the audio out signal 113, the noise signal 115 and the supplemental input 117 as well as any implemented auxiliary inputs 119 to provide a net output signal 196. The net output signal 196 is usable to provide a desired audio source that has been modified to compensate for undesired noise experienced (or that would be experienced) in the vehicle cabin. Such modifications may include, eliminating, altering or replacing the undesired noise.

It should also be appreciated that tweeters, mid-range speakers, full-range speakers, woofers and subwoofers, an excited headliner driven by a transducer and any other known or later-developed type of speaker are all subsets of speakers. As such, any description of a speaker may include any or all of these subsets. While descriptions of tweeters, mid-range speakers, full-range speakers, woofers and subwoofers may not necessarily be interchangeable, any description of a speaker may be interchangeable with any of a description of tweeters, mid-range speakers, full-range speakers, woofers and/or subwoofers, Likewise, any suitable known or later-developed audio producing device can be used, at least in part, with various exemplary embodiments of an overhead audio system according to the disclosure.

While the present disclosure has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the disclosure, as set forth above, are intended to be illustrative, not limiting. Various changes may be made without departing from the spirit or scope of the invention. Therefore, the disclosure and the invention set forth in the appended claims is intended to embrace all known or earlier developed alternatives, modifications, variations, improvements and/or substantial equivalents.

1. An overhead audio system for use in a vehicle, the overhead audio system comprising:
a multiplexor for receiving an audio input signal from a plurality of audio sources and for transmitting an audio output signal;
a noise detection sensor for detecting an undesirable noise and for transmitting an undesirable noise signal;
an audio processor having a digital signal processor and a mixing digital signal processor, wherein the digital signal processor receives and processes the audio output signal and the undesirable noise signal, and wherein the mixing digital signal processor combines the processed audio output signal and the processed undesirable noise signal to create a net output signal that has been modified to compensate for the undesirable noise.

2. The overhead audio system of claim 1, further comprising a supplemental input for providing the mixing digital processor with a replacement sound for the undesirable noise, wherein the replacement sound is a predetermined motor noise.

3. The overhead audio system of claim 1, wherein the audio processor modifies the undesirable noise render the undesirable noise inaudible.

4. The overhead audio system of claim 1, farther comprising a converter for converting an analog signal to a digital signal and for converting a digital signal to an analog signal.

5. The overhead audio system of claim 1, further comprising at least one amplifier for amplifying the output signal to a speaker.

6. The overhead audio system of claim 1, wherein the plurality of audio sources include a AM/FM radio, a compact disc player, an optical disc player, a cassette tape player, a digital audio player, an auxiliary audio input, a Bluetooth device, a USB port, or a wireless audio input device.

7. The overhead audio system of claim 1, further comprising a user interface for operating the overhead audio system.

8. A headliner having an overhead audio system for a vehicle interior, comprising:
a multiplexor for receiving an audio input signal from a plurality of audio sources and for transmitting an audio output signal;
a noise detection sensor for detecting an undesirable noise and for transmitting an undesirable noise signal;
an audio processor having a digital signal processor and a mixing digital signal processor, wherein the digital signal processor receives and processes the audio output signal and the undesirable noise signal, and the mixing digital signal processor combines the processed audio output signal and the processed undesirable noise signal to create a net output signal that has been modified to compensate for the undesirable noise.

9. The headliner of claim 8, wherein the overhead audio system is housed within the headliner of the vehicle and the modified output signal is transmitted into the vehicle interior.

10. The headliner of claim 8, wherein the audio processor modifies the undesirable noise render the undesirable noise inaudible.

11. The headliner of claim 8, further comprising a converter for converting an analog signal to a digital signal and for converting a digital signal to an analog signal.

12. The headliner of claim 8, further comprising at least one amplifier for amplifying the output signal to the speaker.

13. The headliner of claim 8, wherein the plurality of audio sources include a AM/FM radio, a compact disc player, an optical disc player, a cassette tape player, a digital audio player, an auxiliary audio input, a Bluetooth device, a USB port, or a wireless audio input device.

14. The headliner of claim 8, further comprising a user interface for operating the overhead audio system.
